(19) United States
(12) Patent Application Publication
(10) Pub. No.: US 2004/0234726 A1
(43) Pub. Date: Nov. 25, 2004

(54) Material consisting of a polyurethane gel, production method and uses thereof

(76) Inventors: Barbara Pause, Longmont, CO (US); Adolf Stender, Duderstadt (DE); Peter Gansen, Seeburg (DE)

Correspondence Address: Robert C Haldiman, Husch & Eppenberger, Suite 600, 190 Carondelet Plaza, St Louis, MO, 63105, US

(21) Appl. No.: 10/484,528

(22) PCT Filed: Jul. 17, 2002
(86) PCT No.: PCT/DE02/02605

Related U.S. Application Data
(60) Provisional application No. 60/306,644, filed on Jul. 19, 2001.

(30) Foreign Application Priority Data
May 6, 2002 (DE) 02010042.6

(51) Int. Cl. B32B 27/00

(52) U.S. Cl. 428/160; 428/355 N; 428/423.1

(57) ABSTRACT

The invention relates to polyurethane gel materials containing finely-dispersed phase change materials (PCMs), (e.g. crystalline saturated hydrocarbons). Said materials permit a thermal regulation by means of thermal absorption and thermal dissipation in the phase transition range of the PCMs, which becomes apparent in terms of improved comfort in the use of the novel material for shoe soles, bicycle saddles, chair cushions or similar.

The invention relates to a material made from a polyurethane gel having finely dispersed phase transition materials, so-called “Phase Change Materials” (PCM) present therein, a process for producing such materials and associated uses.

The introduction of materials, which absorb and store large quantities of heat from the surroundings during a phase change from the solid to the liquid physical state, into those which do not change the physical state in the same temperature range, leads to a climatising effect, which is required, inter alia, for functional textiles (in the field of sport and leisure).

The phase transition materials, so-called “Phase Change Materials (PCM), introduced or applied have the ability to change their physical state within a certain (required and adjustable) temperature range. A phase transition from the solid to the liquid state occurs on reaching the melting temperature during a heating process. During this melting process, the PCM absorbs and stores considerable latent heat. The temperature of the PCM remains virtually constant during the entire process.

During a subsequent cooling process, the stored heat is released again from the PCM to the surroundings and the reverse phase transition from the liquid to the solid state takes place. The temperature of the PCM remains constant even during this crystallisation process.

Before it is used in functional textiles, the PCM is microencapsulated in order to prevent the leaking of the molten PCM into the textile structure.

For better understanding, the amount of latent heat, which is absorbed by a PCM during the phase transition, is compared with the specific heat in a conventional heating process. The ice-water transition is used for comparison. When ice melts, it absorbs a latent heat of about 335 J/g. When the water is further heated, it absorbs a specific heat of only 4 J/g during a temperature increase of 1° C. The absorption of latent heat during the phase transition from ice to water is therefore almost 100 times greater than the absorption of specific heat during the normal heating process outside the phase transition range.

Apart from the ice/water system, more than 500 natural and synthetic PCMs are known. These materials differ due to their phase transition temperatures and their heat absorption capacities.

Currently, only crystalline hydrocarbon PCMs having different chain length are used for finishing yarns and textiles. The characteristics of these PCMs are summarised in the following Table 1:

| Phase Change | Melting temp. | Crystallisation | Heat storage |
|---|---|---|---|
| Material | [° C.] | temp. [° C.] | capacity [J/g] |
| Heneicosane | 40.5 | 35.9 | 213 |
| Eicosane | 36.1 | 30.6 | 247 |
| Nonadecane | 32.1 | 26.4 | 222 |
| Octadecane | 28.2 | 25.4 | 244 |

The crystalline alkanes are used either in technical purity of about 95% or in mixtures which should cover certain phase transition temperature ranges. The crystalline alkanes are non-toxic, non-corrosive and non-hygroscopic. The thermal behaviour of these PCMs remains stable even during prolonged use. Crystalline alkanes are side-products from oil refineries and therefore cheap. They are pure and can also be obtained in mixtures defined according to the melting range.

Only microencapsulated crystalline alkanes, which are enclosed in small microcapsules having diameters of about 1 to 30 microns, are currently used as PCMs in the textile industry. These microencapsulated PCMs are applied to the textiles by introducing them into acrylic fibres or even polyurethane foams and applying them to the fibres as a coating.

U.S. Pat. No. 4,756,958 describes a fibre with integrated microcapsules which are filled with PCM. The fibre has improved thermal properties in a predetermined temperature range.

U.S. Pat. No. 5,366,801 describes a coating of PCM-filled microcapsules for textiles in order to finish them with improved thermal properties.

U.S. Pat. No. 5,637,389 describes an insulating foam with improved thermal behaviour, in which the PCM microcapsules are embedded in the foam.

Microencapsulation processes are very time-consuming and complicated, multi-stage processes. Microencapsulated PCMs are therefore very expensive.

Apart from in thin coatings, the addition of microencapsulated PCMs is not conventional for plastics (polymers), since the heat transfer in the interior, for example of mouldings, would be very poor.

Polyurethane gels are known, which are characterised, inter alia, by a high deformability, and are used, for example for seat cushions and upholstery. However, these polyurethane gels often lead to an unpleasant cold feeling on body contact and generally to poor climatising.

The object of the invention consists in improving the thermal behaviour of polyurethane gels in the sense of temperature-compensating behaviour.

To achieve this object, the invention provides a material made from a polyurethane gel, which contains therein finely dispersed Phase Change Materials.

It has been found, surprisingly, that the Phase Change Materials do not have to be encapsulated and nevertheless do not diffuse out or agglomerate.

Finely dispersed PCMs, which are emulsified or dispersed in the polyurethane gel, remain stable unchanged over long service lives.

The polyurethanes used for polyurethane gels are covalently crosslinked polyurethane matrices having high molecular weights. The gel structure comes about due to suitable choice of the functionalities and molecular weights of the starting components. The polyurethane gels used may contain admixtures and additives which are conventional in polyurethane chemistry.

The gel compositions used for the invention are preferably produced using raw materials of isocyanate functionality and functionality of the polyol component of at least 5.2, also preferably at least 6.5 and in particular of at least 7.5.

The polyol component for producing the gel may consist of one or more polyols having a molecular weight between 1,000 and 12,000 and an OH number between 20 and 112, wherein the product of the functionalities of the polyurethane-forming components is at least 5.2, as indicated above, and the isocyanate characteristic lies between 15 and 60.

Isocyanates of the formula Q(NCO)n are preferably used for gel production, wherein n represents 2 to 4 and Q is an aliphatic hydrocarbon radical having 8 to 18 C atoms, a cycloaliphatic hydrocarbon radical having 4 to 15 C atoms, an aromatic hydrocarbon radical having 6 to 15 C atoms or an araliphatic hydrocarbon radical having 8 to 15 C atoms. Hence, the isocyanates may be used in pure form or in a conventional isocyanate modification, such as for example urethanisation, allophanatisation or biuretisation, as is known to the expert.

In principle all PCMs may be used as phase transition materials or Phase Change Materials (PCMs), the phase transition of which lies in the required temperature range and which can also be integrated during gel production. These may be, for example paraffins or fats. Crystalline alkanes are preferably used.

The melting points or melting ranges of the PCMs used preferably lie between 20 and 45° C., also preferably between 34 and 39° C. For applications in which the material close to the body should ensure compensation of the body temperature, a phase transition range for average human body temperature is ideal in order to be able to immediately control overheating—for example during sport.

The PCMs are preferably incorporated into the material in a weight proportion of up to 60 wt. %, also preferably up to 40 wt. %, based on the total weight.

In addition, fillers may be present in the material. The expert may select the fillers and the quantities of these fillers which can be used within the framework of what is generally known for this in polymer chemistry and particularly in polyurethane chemistry. In particular resilient microspheres may also be provided as fillers, the shells preferably consist of polymer material, in particular polyolefin. The resilient microspheres may, if it is additionally required, be expanded or expandable under processing conditions. Microspheres are gas-filled (air-filled) microballoons, wherein the sphere shape is immaterial here. Often “microcellular material” or microcells are also mentioned. The microspheres reduce the specific weight and have an effect on the mechanical properties of the material. Up to 20, preferably up to 10 wt. %, of microcells are used. Suitable microspheres, and also other fillers, are commercially available.

The material may be used, inter alia, for the production of shoe insoles, shoe linings, mattresses, seat pads and whole seat cushions. Further additives or fillers may thus be incorporated into the material, as known in the state of the art. Shoe insoles may preferably consist of the novel material at least in some regions, for example in the region of the foot pressure points.

Soles, mattresses, seat pads and cushions may be provided with a textile covering. The material of the invention may be laminated directly to textile materials.

The invention also comprises a process for producing the novel material. The polyurethane components already mentioned above are preferably used. Suitable compositions for polyurethane gels are, for example described in European 057 838 and also European 0 511 570. The PCMs are added to the starting components or at the latest during gel formation. They are thus also permanently integrated into the solid polyurethane structure being formed.

The material of the invention may be produced particularly advantageously by emulsifying or dispersing the Phase Change Material in a liquid PU component, and the PU components are then reacted to form the polyurethane gel. Alternatively, the PCM may also be introduced into the final polyurethane mixture before gel formation. Which procedure is selected also depends on the required dispersion profile. The expert may ascertain using tests, the particular best possibility for incorporating the PCM.

In a particularly preferred embodiment, the Phase Change Material, and specifically preferably an alkane in liquid physical state (molten), is used. The liquid PCM is first of all incorporated into the polyol component with formation of a liquid/liquid emulsion, which polyol component is then further processed as is conventional. The degree of fine dispersion of the PCM in the emulsion depends, inter alia, on intensity and duration with which mixing is carried out, that is generally stirring. In addition, suitable additives, such as stabilisers and emulsifiers, influence the degree of fine dispersion. The expert may adjust this within certain limits and thus influence the dispersion of the PCM in the later material.

The emulsion may preferably be stabilised by the addition of an emulsion stabiliser. For example aerosils may be used for this.

In an alternative embodiment, the liquid Phase Change Material may be mixed with all components of the later gel material and intensively stirred until gel formation starts. With the start of gel formation, the composition is then generally poured into the moulds predetermined by the required products.

In further embodiments, solid, pulverulent PCMs could be incorporated into the gel or dispersed in the polyol component. The processing is effected otherwise in conventional manner.

The use of microencapsulated PCMs would also be possible within the gel material of the invention, but only in an impaired embodiment, since encapsulation fundamentally prevents heat transfer, reduces heat capacity and additionally increases the expense of the product overall.

Polyurethane gels have numerous advantageous properties which are already utilised in the state of the art for many products. These known properties, such as good pressure distribution capacity, high shock and shearing force absorption, high elasticity and good recovery ability, are also retained in the novel material comprising Phase Change Materials. In the novel material, good climatising behaviour, that is good heat-regulation behaviour, is now added to the properties of hitherto known polyurethane gels. The thermal conductivity of PU gels of about 0.410 W/mK, which is high for polymers, permits very good heat transport between PCMs and surroundings.

Particular use possibilities for the novel material can therefore be seen in areas where excess heat, for example from the body of a person, is to be buffered. Excess heat is temporarily absorbed by the material due to the high thermal capacity of the PCM during phase transition and later released again during cooling of the body, that is as required. For example excess heat, which is produced by the foot during running, may be absorbed at times by an insole made from the novel material.

The structure of the polyurethane gel material permits high charging with PCMs, for crystalline alkanes up to about 60 wt. %, based on the total weight of the material, preferably up to 40 wt. %. In addition, the polyurethane gel may contain further additives, in particular those which are already known for polyurethane gels, for example particles of low density.

For example a heat absorption capacity of about 140 kJ/m² may be achieved in a polyurethane gel material having a thickness of 1.5 mm and a weight of 1,760 g/m², if crystalline alkanes having a latent heat capacity of about 200 J/g are used. The heat storage capacity may be increased to about up to 250 kJ/m², if the alkane PCM is used in a gel material having a specific weight of 3,150 g/m². The heat absorption capacity which may be achieved in this manner exceeds by far the capacity of current PU foams with microencapsulated PCMs, which lies at 20 to 40 kJ/m². Textiles coated with microencapsulated PCMs have latent heat absorption capacities of between 5 kJ/m² and 15 kJ/m².

The invention is illustrated below using examples of insoles.

### EXAMPLES

Insoles made from PCM-containing polyurethane gel

The excess heat released from the foot should be absorbed by the PCM and hence the temperature rise on the skin should be noticeably delayed. The delay of the temperature rise leads to sweat formation which starts later and is also less, which results in a considerable improvement in the thermophysiological comfort. A significant improvement in wearer comfort when using the insoles in the widest variety of shoe variants is achieved from the combination of excellent mechanical properties of the polyurethane gel materials and the thermal effect of the PCMs.

1. Determination of thermophysical characteristics

The investigations were carried out on the following insoles:

A. PCM-containing PU gel sole with 20% paraffin PCM

B. PCM-containing PU gel sole with 40% paraffin PCM

C. PCM-containing PU gel sole with 10% microencapsulated paraffin PCM (THS 95)

D. PCM-containing PU gel sole with 20% microencapsulated paraffin PCM (THS 95)

E. PU gel insole without PCM

F. PU gel insole with 25% paraffin PCM (CeraSer 318)

G. PU gel insole with 25% paraffin PCM (CeraSer 318) and 2% microspheres

The percentage details relate in each case to wt. % based on the total weight of the material.

Commercially available pure paraffins and paraffin mixtures, which are characterised by their melting range or melting point, were used as paraffin PCM (a commercially available paraffin mixture is, for example Cera Ser®).

The temperature ranges of latent heat absorption and release of the paraffin PCM present in the insoles were ascertained with the aid of a calorimetric DSC measuring apparatus and its heat storage capacity determined.

The results of the DSC test are summarised in Table 1. The temperature ranges of the latent heat absorption and the latent heat release, the melting and crystallisation temperatures (peak values) and the latent heat absorptions and releases were ascertained in these measurements for the paraffin PCMs present in the PU gel insoles. All results are average values of in each case three tests.

TABLE 1
Measured results of the DSC test

| | Temp. | Melting | Latent heat | Temp. | Crystallisation | Latent heat |
|---|---|---|---|---|---|---|
| Test | range heat | temp. | absorption | range heat | temp. (Peak) | release in |
| material | absorption in ° C. | (Peak) in ° C. | in J/g | release in ° C. | in ° C. | J/g |
| A | 18-38 | 32.86 | 9.78 | 10-35 | 28.46 | 11.29 |
| B | 18-45 | 35.40 | 20.98 | 15-38 | 34.23 | 21.54 |
| C | 25-38 | 35.04 | 9.44 | 13-23 | 18.38 | 1.55 |
| | | | | 23-35 | 32.11 | 5.45 |
| D | 25-38 | 35.03 | 12.25 | 13-23 | 17.97 | 2.11 |
| | | | | 23-35 | 32.26 | 6.49 |

In addition, the influence of fillers was investigated. The results of DSC tests on in each case one insole with and without microcells or microspheres in the gel, and a sole without PCMs, are summarised in Table 2. All results are average values of in each case three measurements.

TABLE 2
DSC on PCM-PU gel insoles with and without microspheres

| | Temp. | Melting | Latent heat | Temp. | Crystallisation | Latent heat |
|---|---|---|---|---|---|---|
| Test | range heat | temp. | absorption | range heat | temp. (Peak) | release in |
| material | absorption in ° C. | (Peak) in ° C. | in J/g | release in ° C. | in ° C. | J/g |
| PU gel | 15-20 | 18.01 | 0.39 | 10-17 | 15.42 | 0.53 |
| 25% | 20-40 | 35.27 | 19.56 | 17-36 | 31.29 | 21.78 |
| CeraSer | | | | | | |
| 318 | | | | | | |
| without | | | | | | |
| MB | | | | | | |
| PU gel | 15-20 | 18.21 | 0.38 | 10-17 | 14.85 | 0.37 |
| 25% | 25-43 | 35.56 | 17.40 | 17-37 | 32.36 | 18.11 |
| CeraSer | | | | | | |
| 318 | | | | | | |
| with | | | | | | |
| MB | | | | | | |

MB = Microcells/microspheres

The measured results from Table 2 show that the latent heat capacity of the insoles is reduced by about 15% by the addition of about 2% of air-filled microcells (MB). The temperature ranges of the latent heat absorption or heat release are displaced slightly to higher temperatures by the addition of the air-filled microcells.

The PU gel insoles used have different sizes and, inter alia, consequently also have different weights. Table 3 contains the weights of the insoles used in the investigations. The latent heat storage capacity of the insoles was ascertained with reference to the sole weight. The value indicated in brackets relates to a uniform insole size, which corresponds to the shoe size 39/40. The sole size was used in the wear tests.

TABLE 3
Weights of the insoles and latent heat storage capacity of the paraffin
PCM present in the soles

| | Weight | Latent heat storage |
|---|---|---|
| Insole | in g | capacity in kJ |
| A | 68 | 0.7 |
| B | 69 | 1.6 |
| C | 84 | 0.6 (0.4) |
| D | 84 | 0.8 (0.7) |
| E | 50 | — |

2. Property tests—wear tests

The properties of the various soles were investigated by wear tests with test people.

The tests consisted of a 30-minute run in a climatic chamber on the running belt ergometer at a speed of about 8 km/h. During the test, the ambient temperature was 21° C. and the relative air moisture 40%. For the tests, the particular sole model was inserted in a normal sports shoe. In the tests, cotton socks and normal sports clothing were worn by the test people.

During the test, the temperature course was ascertained continuously using a logger system at a total of 4 skin measuring points (big toe, back of the foot, top bone and base of the foot) and at two points on the surface of the insole. The average skin temperature was calculated from the temperature measured values at the four different skin measuring points. The measured results of the two sensors which were located on the surface of the insole were likewise averaged. In addition, the moisture rise was determined in the microclimate. Each sole model was tested twice and the test results obtained were averaged.

The following were investigated:

1. Polyurethane gel insole without PCM;

2. Polyurethane gel insole with 25% microencapsulated PCM;

3. Polyurethane gel insole with 25% pure PCM;

4. Polyurethane foam insole with 50% microencapsulated PCM (% details in each case in wt. %)

The investigation results are shown below using figures:

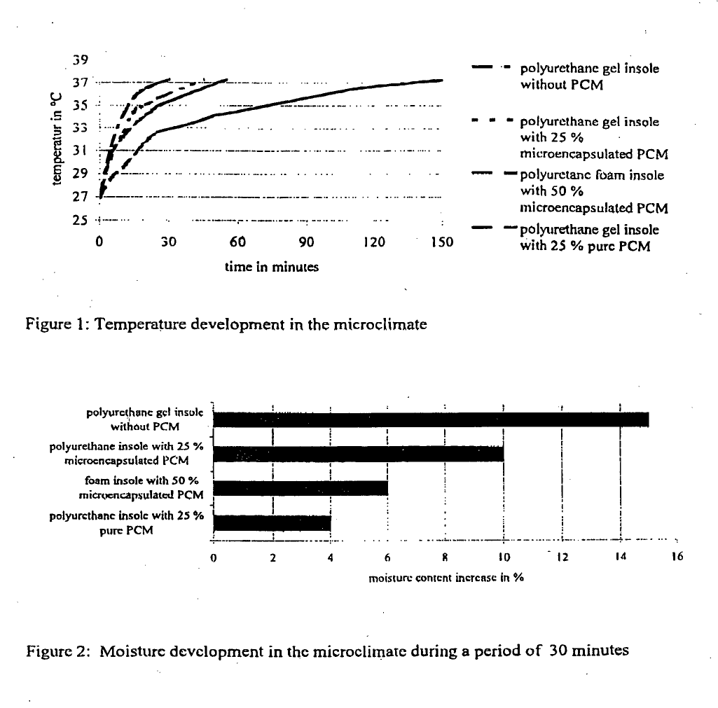

FIG. 1: Temperature development in shoe microclimate;

FIG. 2: Moisture development over 30 minutes

In the 30-minute running test, the temperatures shown in FIG. 1 were measured on the surface of the PU gel insoles.

The test results show that when using a polyurethane gel insole without PCM, even after 30 minutes a final temperature of about 37° C. is achieved in the running shoe microclimate. By adding 25% of microencapsulated PCMs to this polyurethane gel insole, this time span is already extended by about 15 minutes. However, the use of 25% pure, non-encapsulated PCM extends the time span to reaching the final temperature to at total of 150 minutes. A considerable and long-lasting cooling effect is therefore achieved by using non-encapsulated PCMs in the polyurethane gel insole.

The reason for the only shorter cooling effect of the corresponding sole with microencapsulated PCM can be seen due to losses of the latent heat capacity through the microencapsulation itself and a greater heat-transfer resistance to the microcapsules. In spite of the considerably higher PCM proportion, a significantly lower cooling effect is achieved in the PU foam sole with microencapsulated PCM, which is caused by the severely impeded and delayed heat transfer in the foam and through the microcapsules.

Delay of the temperature rise in the shoe microclimate during running is also shown in a delayed moisture rise. The test results for the moisture increase in the microclimate of the shoe during running over a period of 30 minutes are summarised in FIG. 2.

FIG. 2 shows that the heat absorption by the PCM leads to a considerably lower moisture rise in the microclimate of the shoe. This leads overall to a significant increase in comfort when wearing the insoles of the invention.

The material of the invention made from PCM-containing polyurethane gel may also improve the climatising behaviour of bicycle seats, chair cushions, car seats, wheelchair seats or mattresses, to mention just a few examples.

1-16. (Canceled).

17. A material having a temperature-compensating behaviour made from a polyurethane gel having finely dispersed “Phase Change Materials” present therein, the melting points or ranges of which lie between 20° C. and 45° C.

18. A material according to claim 17, characterized in that the polyurethane gel is produced using raw materials of isocyanate functionality and functionality of the polyol component of at least 5.2, preferably of at least 6.5, in particular of at least 7.5.

19. A material according to claim 17, characterized in that paraffins or fats are used as Phase Change Materials.

20. A material according to claim 17, characterized in that the Phase Change Materials have melting points or melting ranges between 34 and 39° C.

21. A material according to claim 17, characterized in that the Phase Change Materials are present in the material in a weight proportion of up to 60 wt. %, preferably up to 40 wt. %, based on the total weight.

22. A material according to claim 17, further including fillers, in particular resilient microspheres, preferably those made from polymer material.

23. A material according to claim 17, in which the Phase Change Material is emulsified or dispersed in at least one liquid PU component before reaction to form the gel.

24. A process for producing a material having a temperature-compensating behaviour including the steps of: emulsifying a Phase Change Material in at least one liquid PU component, and reacting the PU components to form a polyurethane gel.

25. A use of a material having a temperature-compensating behaviour made from a polyurethane gel having finely dispersed “Phase Change Materials” present therein, the melting points or ranges of which lie between 20° C. and 45° C. for the production of articles from the group consisting of: shoe insoles, shoe linings, mattresses, seat pads, and seat cushions.

26. A shoe insole including a material having in some regions a temperature-compensating behaviour made from a polyurethane gel having finely dispersed “Phase Change Materials” present therein, the melting points or ranges of which lie between 20° C. and 45° C., and a textile covering.
